(19) United States
(12) Patent Application Publication
(10) Pub. No.: US 2026/0275556 A1
(43) Pub. Date: Sep. 17, 2026

(54) ELECTROLYSIS APPARATUS

(71) Applicant: HYDEP S.R.L., Lodi (LO) (IT)

(72) Inventors: Matteo DRAGONI, Castiglione d'Adda (LO) (IT); Mario DRAGONI, Castiglione d'Adda (LO) (IT)

(73) Assignee: HYDEP S.R.L., Lodi (LO) (IT)

(21) Appl. No.: 19/472,508

(22) PCT Filed: Apr. 12, 2024
(86) PCT No.: PCT/IB2024/053598

§ 371 Date: Oct. 3, 2025

(30) Foreign Application Priority Data
Apr. 14, 2023 (IT) 102023000007206

(51) Int. Cl. C25B 15/08; C25B 1/04; C25B 9/67; C25B 9/77; C25B 15/027

(52) U.S. Cl. CPC C25B 15/087; C25B 9/67; C25B 9/77; C25B 15/027; C25B 1/04

(57) ABSTRACT

An electrolysis apparatus for the production of gaseous hydrogen and oxygen by water electrolysis includes an electrolyzer having a plurality of cells arranged next to each other to form a cell stack. Each cell includes an anode and a cathode plate. The electrolyzer further includes anode and cathode end plates. The electrolyzer has an active chamber in which the electrolysis reaction of water contained in an electrolyte solution with which the electrolyzer is fed takes place, a first liquid/gas phase separator for separating oxygen gas from the electrolyte solution, and a second liquid/gas phase separator for separating hydrogen gas from the electrolyte solution. The electrolyzer also includes a plurality of sensors mounted on one of the anode and cathode end plates and configured to detect appropriate operating parameters of the first and second liquid/gas phase separator.

### TECHNICAL FIELD OF THE INVENTION

The present invention generally relates to an electrolysis apparatus for the production of hydrogen and oxygen by water electrolysis process. More specifically, the present invention relates to an electrolysis apparatus with an electrolyzer having liquid/gas phase separators integrated therein.

### STATE OF THE ART

Hydrogen is considered the energy carrier of the future, enabling massive storage of renewable energy sources.

The use of water electrolysis technology allows the production of hydrogen and oxygen without any trace of carbon compounds, unlike steam methane reforming. Water electrolysis is performed using appropriate electrochemical reactors, known as electrolyzers, which comprise a plurality of cells arranged in series, physically separated from each other by bipolar plates, and electrically connected to each other. Each cell comprises a pair of electrodes (anode and cathode) that are separated from each other by permeable membranes or diaphragms. By application of electric current, the water contained in an electrolyte solution with which the electrolyzer is fed is dissociated into hydrogen and oxygen, which are collected on the cathode and anode of each cell of the electrolyzer, respectively.

FIG. 1 of the attached drawings schematically shows an example of a traditional architecture of an apparatus for the production of gaseous hydrogen by water electrolysis. Referring to that figure, an electrolyzer 10 is connected to a first liquid/gas phase separator 12 via a first supply conduit 14 and a first return conduit 16 and to a second liquid/gas phase separator 18 via a second supply conduit 20 and a second return conduit 22. Through the first supply conduit 14 the mixture containing electrolyte solution and oxygen produced in the electrolyzer 10 is sent to the first liquid/gas phase separator 12, where separation of the oxygen from the electrolyte solution takes place. The oxygen thus separated is properly utilized, while the electrolytic solution returns to the electrolyzer 10 through the first return conduit 16 under the action of a first pump 24 mounted along that conduit. Likewise, through the second supply conduit 20 the mixture containing electrolytic solution and hydrogen produced in the electrolyzer 10 is sent to the second liquid/gas phase separator 18, where separation of the hydrogen from the electrolytic solution takes place. The hydrogen thus separated is properly utilized, while the electrolytic solution returns to the electrolyzer 10 through the second return conduit 22 under the action of a second pump 26 mounted along that conduit. Each of the two liquid/gas phase separators 12 and 18 is equipped with a safety valve SV, a pressure sensor PS, a temperature sensor TS, a high-pressure switch HPS, and a level sensor LS.

In order to reduce hydrogen production costs, electrolyzers have been developed that integrate liquid/gas phase separators within them. In this way, the separation of the hydrogen gas and oxygen gas from the electrolytic solution takes place directly within each electrolyzer cell. The hydrogen gas and oxygen gas thus separated are taken out of the cell for appropriate use, while the liquid phase (electrolyte solution) is caused to flow from the respective separation chamber to the active chamber of the same cell through a respective channel. This makes it possible to increase standardization of the electrolyzer, and thus reduce its cost. In addition, this type of electrolyzer provides a faster response than conventional electrolyzers, since gases and liquids are separated within each cell of the electrolyzer, without having to be brought out of the electrolyzer.

### SUMMARY OF THE INVENTION

It is an object of the present invention to provide an electrolysis apparatus of an improved type over the prior art discussed above.

This and other objects are achieved according to the invention by virtue of an electrolysis apparatus as defined in the attached independent claim 1.

Additional advantageous aspects of the electrolysis apparatus according to the invention are defined in the dependent claims, the subject-matter of which is to be intended as forming an integral part of the following description.

In summary, the present invention is based on the idea of mounting on at least one of the two end plates of the electrolyzer a set of sensors arranged to detect appropriate operating parameters of the electrolyzer, particularly appropriate operating parameters of the liquid/gas phase separators integrated within the electrolyzer.

Mounting these sensors on board of the electrolyzer, rather than on liquid/gas phase separators or other external components separate from the electrolyzer, offers a number of advantages, including:
reduction of the costs thanks to the reduction of the footprint of the electrolysis apparatus, for the same hydrogen and oxygen production capacity;
reduction of the costs due to the reduction of assembly time of the electrolysis apparatus;
reduction of the costs due to the ability to pre-calibrate and/or pre-set the sensors during the test phase of the electrolyzer on a test bench; and
faster intervention in case of any malfunction of the electrolyzer, since the sensors are placed close to the electrolyzer stack, rather than at some distance therefrom as in the prior art.

Preferably, these sensors comprise a first level sensor for detecting the liquid level in the first liquid/gas phase separator (i.e., in the phase separator in which oxygen separation takes place), a first temperature sensor for detecting the temperature in the first liquid/gas phase separator, a first pressure sensor for detecting the pressure in the first liquid/gas phase separator, a second level sensor for detecting the liquid level in the second liquid/gas phase separator (i.e., in the phase separator where hydrogen separation takes place), a second temperature sensor for detecting the temperature in the second liquid/gas phase separator, and a second pressure sensor for detecting the pressure in the second liquid/gas phase separator. These sensors are in communication with a control unit of the electrolysis apparatus to allow the control unit to appropriately manage the operation of the apparatus based on the signals provided by these sensors.

In addition, according to the invention fluid circulation means, such as pumps, are associated with the electrolyzer for generating a forced flow of electrolyte solution from each of the two liquid/gas phase separators to the active chamber of the electrolyzer. In this way, a reduction in the electrolyzer start-up time is achieved compared with the case of natural circulation of the electrolyte solution, as is provided in the electrolyzer known from WO2010/006423.

In addition, the electrolyzer is advantageously provided with a pair of safety valves, each associated with a respective liquid/gas phase separator to limit the pressure within the separator to a given predeterminable maximum value. These valves are also mounted on at least one of the two end plates of the electrolyzer, that is, either both valves in the same end plate or one valve in one end plate and the other valve in the other end plate.

According to an embodiment, the electrolyzer is also provided with a pair of high-pressure switches, each associated with a respective liquid/gas phase separator and arranged to intervene, if a given pressure value is exceeded in the associated liquid/gas phase separator, by cutting off the power supply to the electrolyzer. Such high-pressure switches are also advantageously mounted on at least one of the two end plates of the electrolyzer, i.e., either both switches in the same end plate or one switch in one end plate and the other switch in the other end plate, so as to be located in close proximity to the respective separators and thus able to intervene very quickly if the pressure set-point value is reached.

### BRIEF DESCRIPTION OF THE DRAWINGS

Further features and advantages of the present invention will result more clearly from the following description, given purely by way of non-limiting example with reference to the accompanying drawings, in which:

FIG. 1 schematically shows an example of a traditional architecture of an apparatus for the production of gaseous hydrogen by water electrolysis:

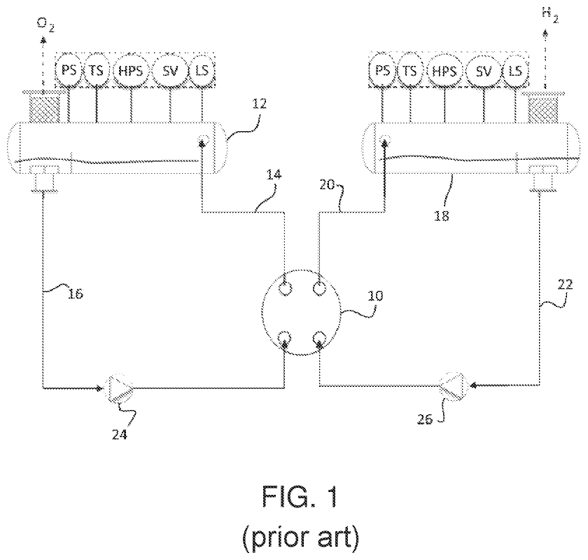

FIG. 2 schematically shows the architecture of an electrolysis apparatus for the production of gaseous hydrogen by water electrolysis comprising an electrolyzer according to the present invention;

FIG. 3 is an exploded view of the electrolyzer of the apparatus of FIG. 2;

FIG. 4 shows an anode plate of one of the cells of the electrolyzer of FIG. 3; and

FIG. 5 shows a cathode plate of one of the cell of the electrolyzer of FIG. 3.

### DETAILED DESCRIPTION

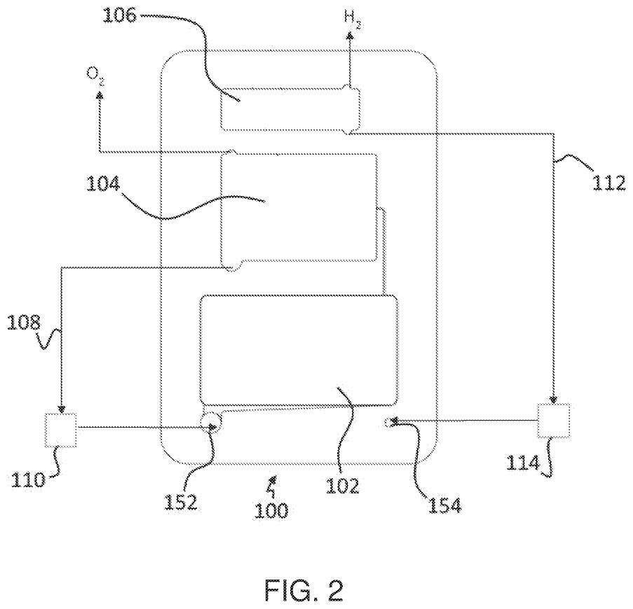

With reference first to FIG. 2, an electrolyzer according to the present invention is generally indicated with 100. Within the electrolyzer 100 an active chamber 102 is defined, in which the electrolysis reaction of the water contained in an electrolyte solution takes place, resulting in the dissociation of water molecules into hydrogen and oxygen. In addition, electrolyzer 100 integrates within it a first liquid/gas phase separator 104 for the separation of oxygen gas from the liquid phase formed by the electrolytic solution and a second liquid/gas phase separator 106 for the separation of hydrogen gas from the liquid phase formed by the electrolytic solution. The electrolytic solution separated from the oxygen in the first liquid/gas phase separator 104 is returned to the active chamber 102 via a first return conduit 108 extending outside the electrolyzer 100, under the control of a first pump 110 (or any other device suitable for producing forced circulation of the liquid). Likewise, the electrolyte solution separated from hydrogen in the second liquid/gas phase separator 106 is returned to the active chamber 102 via a second return conduit 112 extending outside the electrolyzer 100, under the control of a second pump 114 (or any other device suitable for producing forced circulation of the liquid). In addition, a series of sensors, described in more detail below, are integrated into the electrolyzer 100 to enable control of the operation of the two liquid/gas phase separator devices 104 and 106.

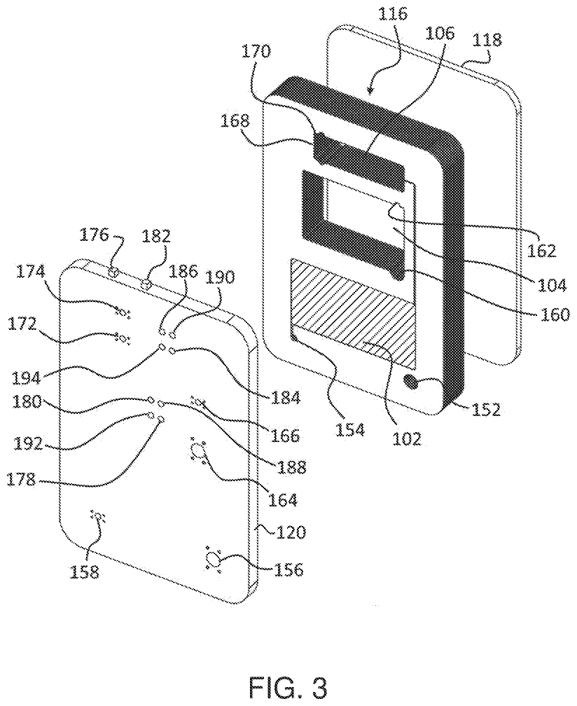

Referring now to FIG. 3, the electrolyzer 100 comprises a plurality of cells arranged next to each other to form a so-called cell stack, generally denoted as 116. The cell stack 116 is clamped between an anode end plate 118 and a cathode end plate 120.

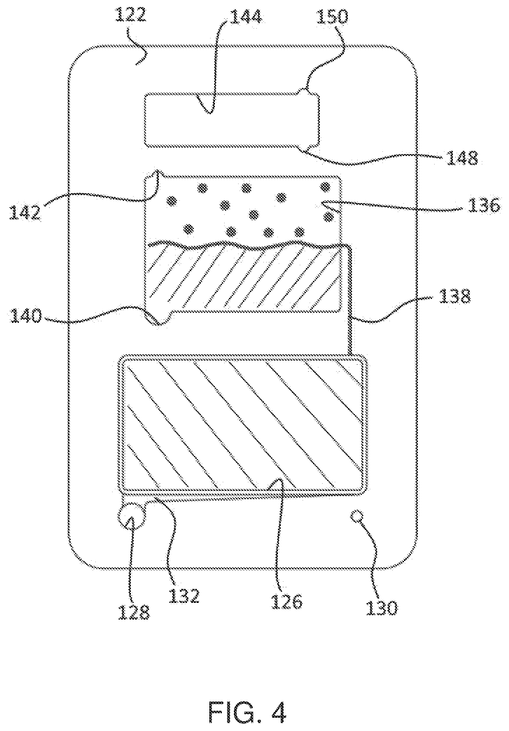

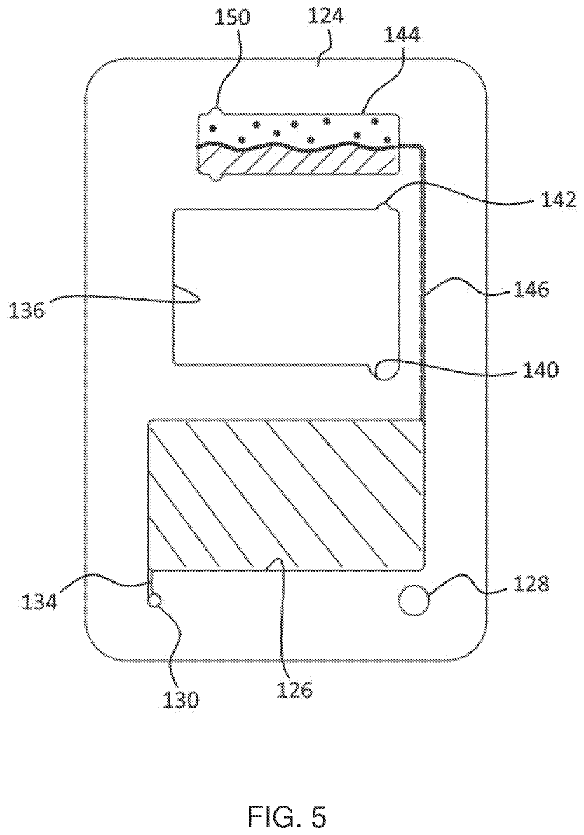

Each cell in cell stack 116 comprises an anode plate 122 (FIG. 4) and a cathode plate 124 (FIG. 5), between which a membrane (not shown) is interposed.

As shown in FIGS. 4 and 5, first of all both the anode plate 122 and the cathode plate 124 of each cell have a respective main opening 126, located in particular in the lower region of the plate. In the anode plates 122 the main opening 126 serves as anode chamber to which the oxygen molecules produced as a result of water electrolysis migrate, while in the cathode plates 124 the main opening 126 serves as cathode chamber to which the hydrogen molecules produced as a result of water electrolysis migrate.

Both the anode plate 122 and the cathode plate 124 of each cell also have a respective first inlet hole 128 and a respective second inlet hole 130. In the anode plates 122, the first inlet hole 128 is in fluid communication with the main opening 126 via a passage 132 formed on one face of the plate 122, while the second inlet hole 130 is not in fluid communication with the main opening 126. In the cathode plates 124, on the other hand, the first inlet hole 128 is not in fluid communication with the main opening 126, while the second inlet hole 130 is in fluid communication with the main opening 126 via a passage 134 formed on one face of the plate 124.

Both the anode plate 122 and the cathode plate 124 of each cell also have a respective secondary first opening 136, located in particular in a central region of the plate, which acts as a liquid/gas phase separator for the separation of oxygen from the electrolyte solution. In the anode plates 122, the first secondary opening 136 is in fluid communication with the main opening 126 via a channel 138 made on one face of the plate 122, so that the mixture of electrolyte solution and oxygen that is produced in the main opening 126 is allowed to flow towards the first secondary opening 136 for the separation of the oxygen gas from the electrolyte solution. In the cathode plates 124, on the other hand, the first secondary opening 136 is not in fluid communication with the main opening 126. At a lower side of the first secondary opening 136 there is provided, both in each anode plate 122 and in each cathode plate 124, a first lower outlet hole 140 for the exit of the liquid phase (electrolyte solution), while at an upper side of the first secondary opening 136 there is provided, both in each anode plate 122 and in each cathode plate 124, a first upper outlet hole 142 for the exit of the gaseous phase (oxygen).

Finally, both the anode plate 122 and the cathode plate 124 of each cell also have a respective second secondary opening 144, located in particular in an upper region of the plate, which acts as a liquid/gas phase separator for the separation of hydrogen from the electrolyte solution. In the anode plates 122, the second secondary opening 144 is not in fluid communication with the main opening 126 and therefore does not receive from the latter a liquid/gas mixture to be separated. In the cathode plates 124, on the other hand, the second secondary opening 144 is in fluid communication with the main opening 126 via a channel 146 made on one face of the plate 124, so that the mixture of electrolyte solution and hydrogen that is produced in the main opening 126 is allowed to flow towards the second secondary opening 144 for the separation of the hydrogen gas from the electrolyte solution. At a lower side of the second secondary opening 144 there is provided, both in each anode plate 122 and in each cathode plate 124, a second lower outlet hole 148 for the exit of the liquid phase (electrolytic solution), while at an upper side of the second secondary opening 144 there is provided, both in each anode plate 122 and in each cathode plate 124, a second upper outlet hole 150 for the exit of the gaseous phase (hydrogen).

Appropriate sealing gaskets (not shown) are arranged around the main openings 126, the first secondary openings 136 and the second secondary openings 144 so as to seal each opening tightly against the other, leaving only open any fluid communication through the aforementioned channels 138 and 146.

As shown in FIG. 3, in the assembled condition of the cell stack 116 the main openings 126 of the anode plates 122 and of the cathode plates 124 are aligned with each other to form the active chamber 102. Likewise, the first inlet holes 128 and the second inlet holes 130 of the anode plates 122 and of the cathode plates 124 are also aligned with each other to form a first feed manifold 152 and a second feed manifold 154, respectively, that run through the entire cell stack 116. One of the two end plates 118 and 120, in the present case the cathode end plate 120, has a first pair of through holes 156 and 158, which in the assembled condition of the electrolyzer 100 are aligned with the first feed manifold 152 and the second feed manifold 154, respectively, to allow the active chamber 102 to be fed with the electrolyte solution that is recovered from the two liquid/gas phase separators 104 and 106. More specifically, the electrolyte solution that is recovered from the first liquid/gas phase separator 104 returns to the electrolyzer 100 through the through hole 156 and then flows along the first feed manifold 152 reaching the main openings 126 of the anode plates 122 only, through the channels 132 provided in those plates, while the electrolyte solution that is recovered from the second liquid/gas phase separator 106 returns to the electrolyzer 100 through the through hole 158 and then flows along the second feed manifold 154 reaching the main openings 126 of the cathode plates 124 only, through the channels 134 provided in those plates.

Still with reference to FIG. 3, in the assembled condition of cell stack 116 the first secondary openings 136 of the anode plates 122 and of the cathode plates 124 are aligned with each other to form the first liquid/gas phase separator 104, while the second secondary openings 144 of the anode plates 122 and of the cathode plates 124 are aligned with each other to form the second liquid/gas phase separator 106.

The first lower outlet holes 140 and the first upper outlet holes 142 of the anode plates 122 and of the cathode plates 124 are aligned with each other to form a first lower discharge manifold 160 and a first upper discharge manifold 162, respectively. One of the two end plates 118 and 120, in the present case the cathodic end plate 120, has a second pair of through holes 164 and 166, which in the assembled condition of the electrolyzer 100 are aligned with the first lower discharge manifold 160 and the first upper discharge manifold 162, respectively, to allow the electrolytic solution and oxygen, respectively, which are separated from each other in the first liquid/gas phase separator 104, to escape from the electrolyzer 100.

Likewise, the second lower outlet holes 148 and the second upper outlet holes 150 of the anode plates 122 and of the cathode plates 124 are aligned with each other to form a second lower discharge manifold 168 and a second upper discharge manifold 170, respectively. One of the two end plates 118 and 120, in the present case the cathodic end plate 120, has a third pair of through holes 172 and 174, which in the assembled condition of the electrolyzer 100 are aligned with the second lower discharge manifold 168 and the second upper discharge manifold 170 to allow the electrolyte solution and hydrogen, respectively, which are separated from each other in the second liquid/gas phase separator 106, to escape from the electrolyzer 100.

The electrolyte solution recovered from the first liquid/gas phase separator 104 then exits the electrolyzer 100 through the through hole 164 and, after flowing through the first return conduit 108 under the action of the first pump 110, returns to the electrolyzer 100 through the through hole 156. Likewise, the electrolyte solution recovered from the second liquid/gas phase separator 106 exits the electrolyzer 100 through the through hole 172 and, after flowing through the second return conduit 112 under the action of the second pump 114, returns to the electrolyzer 100 through the through hole 158.

Downstream of the first pump 110 and the second pump 114, respective heat exchangers (not shown) may be provided along the first return conduit 108 and along the second return conduit 112, respectively, with the function of reducing the temperature of the electrolyte solution before it enters the electrolyzer, thereby preventing the temperature of the electrolyte solution inside the electrolyzer from reaching an excessively high value.

Still with reference to FIG. 3, the electrolyzer 100 is provided with a set of sensors arranged to detect appropriate operating parameters of the electrolyzer, in particular appropriate operating parameters of the liquid/gas phase separators 104 and 106 integrated within the electrolyzer. Such sensors are mounted on at least one of the two end plates 118 and 120. In the example proposed herein, such sensors are all mounted on the cathodic end plate 120, but might alternatively all be mounted on the anode end plate 118 or part on one end plate and part on the other end plate.

More specifically, such sensors comprise a first group of sensors associated with the first liquid/gas phase separator 104, in particular a first level sensor for detecting the liquid level in that separator, a first temperature sensor for detecting the temperature in that separator, and a first pressure sensor for detecting the pressure in that separator, which sensors are respectively mounted at a hole 176, a hole 178, and a hole 180 provided in the cathode end plate 120. In addition, such sensors comprise a second group of sensors associated with the second liquid/gas phase separator 106, in particular a second level sensor for detecting the liquid level in that separator, a second temperature sensor for detecting the temperature in that separator, and a second pressure sensor for detecting the pressure in that separator, which sensors are respectively mounted at a hole 182, a hole 184, and a hole 186 provided in the cathode end plate 120. These sensors are not shown in the drawings and are not described in detail herein, as they are well known to a person skilled in the art.

In addition, the electrolyzer 100 has a first safety valve (not shown, but nevertheless of a per-se-known type) associated with the first liquid/gas phase separator 104 to limit the pressure within that separator and a second safety valve (also not shown, but nevertheless of a per-se-known type) associated with the second liquid/gas phase separator 106 to limit the pressure within that separator. Such valves are also mounted on at least one of the two end plates 118 and 120 of the electrolyzer 100, in the present case in the cathode end plate 120, specifically at a hole 188 and a hole 190, respectively. Alternatively, such valves might both be mounted on the anode end plate 118 or one on one end plate and the other on the other end plate.

Finally, the electrolyzer 100 is also provided with a first high-pressure switch (not shown, but nevertheless of a per-se-known type) associated with the first liquid/gas phase separator 104 and a second high-pressure switch (also not shown, but nevertheless of a per-se-known type) associated with the second liquid/gas phase separator 106, these pressure switches being arranged to intervene, in the event that a given pressure value in the associated liquid/gas phase separator is exceeded, by cutting off the power supply to the electrolyzer 100. Such pressure switches are advantageously mounted on at least one of the two end plates 118 and 120 of the electrolyzer 100, in the present case on the cathodic end plate 120 at respective holes 192 and 194, but alternatively they might be mounted both on the anode end plate 118 or one on one end plate and the other on the other end plate.

The present invention has been described herein with reference to a preferred embodiment thereof, but it is clear that other embodiments may be envisaged which share the same inventive core with the one described here, as defined by the appended claims.

1. An electrolysis apparatus for the production of gaseous hydrogen and oxygen by water electrolysis, with:
an electrolyzer comprising a plurality of cells arranged next to each other to form a cell stack,
wherein each cell includes an anode plate and a cathode plate,
wherein the electrolyzer also includes an anode end plate and a cathode end plate, and the cell stack (116) is clamped between said anode end plate and cathode end plate,
wherein an active chamber is integrated in the electrolyzer, the electrolysis reaction of water contained in an electrolyte solution with which the electrolyzer is fed taking place in said active chamber, wherein said active chamber is formed by a plurality of main openings, each opening being formed in a respective anode plate and a respective cathode plate of each of the cells of the cell stack,
wherein the electrolyzer (100) further comprises a first liquid/gas phase separator (104) integrated in the electrolyzer for separating oxygen gas from the electrolytic solution, said first liquid/gas phase separator being formed by a plurality of first secondary openings, each of said first secondary openings being formed in a respective anode plate and in a respective cathode plate of each of the cells of the cell stack, and a second liquid/gas phase separator for separating hydrogen gas from the electrolyte solution, said second liquid/gas phase separator being formed by a plurality of second secondary openings, each of said second secondary openings being formed in a respective anode plate and in a respective cathode plate of each of the cells of the cell stack, and
wherein the electrolyzer also includes a plurality of sensors mounted on at least one of said anode and cathode end plates and configured to detect appropriate operating parameters of said first and second liquid/gas phase separator;
a control unit configured to control operation of the apparatus based on signals received from said sensors mounted on the electrolyzer;
a first return conduit that extends outside the electrolyzer and is connected both with said first liquid/gas phase separator and with said active chamber of the cell stack to cause the electrolyte solution recovered from said first liquid/gas phase separator to return to said active chamber;
a second return conduit that extends outside the electrolyzer and is connected both with said second liquid/gas phase separator and with said active chamber of the cell stack to cause the electrolyte solution recovered from said second liquid/gas phase separator to return to said active chamber;
a first fluid circulation system associated with said first return conduit to generate a forced flow of electrolyte solution in said first return conduit, and
a second fluid circulation system associated with said second return conduit to generate a forced flow of electrolyte solution in said second return conduit.

2. The electrolysis apparatus of claim 1, wherein said first fluid circulation system and/or said second fluid circulation system comprise a respective pump.

3. The electrolysis apparatus of claim 1, further comprising a first heat exchanging system associated with said first return conduit for cooling the electrolyte solution flowing along said conduit, and a second heat exchanging system associated with said second return conduit for cooling the electrolyte solution flowing along said conduit.

4. The electrolysis apparatus of claim 1, wherein said plurality of sensors comprises one or more of the following sensors: a first level sensor for detecting the liquid level in said first liquid/gas phase separator, a first temperature sensor for detecting the temperature in said first liquid/gas phase separator, a first pressure sensor for detecting the pressure in said first liquid/gas phase separator, a second level sensor for detecting the liquid level in said second liquid/gas phase separator, a second temperature sensor for detecting the temperature in said second liquid/gas phase separator, and a second pressure sensor for detecting the pressure in said second liquid/gas phase separator.

5. The electrolysis apparatus of claim 1, wherein the electrolyzer further comprises a pair of safety valves, associated one with said first liquid/gas phase separator for limiting the pressure within said separator to a given predeterminable maximum value and the other with said second liquid/gas phase separator for limiting the pressure within said separator to a given predeterminable maximum value, wherein said safety valves are mounted on at least one of said anode and cathode end plates.

6. The electrolysis apparatus of claim 1, wherein the electrolyzer further comprises a pair of high-pressure switches, associated one with said first liquid/gas phase separator and the other with said second liquid/gas phase separator and arranged to intervene if a given pressure value is exceeded in the associated liquid/gas phase separator, by cutting off power supply to the electrolyzer, wherein said high-pressure switches are mounted on at least one of said anode and cathode end plates.

7. The electrolysis apparatus of claim 1, wherein said first return conduit is connected with said first liquid/gas phase separator and with said active chamber of the cell stack of the electrolyzer via a first through hole and a second through hole provided in the anode end plate or in the cathode end plate of the electrolyzer, respectively, and wherein said second return conduit is connected with said second liquid/gas phase separator and with said active chamber of the cell stack of the electrolyzer via a third through hole and a fourth through hole provided in the anode end plate or in the cathode end plate of the electrolyzer, respectively.

8. The electrolysis apparatus of claim 7, wherein said first, second, third, and fourth through holes are provided in a same end plate of the electrolyzer, in particular in the cathode end plate.
